(19) United States
(12) Patent Application Publication
(10) Pub. No.: US 2025/0151020 A1
(43) Pub. Date: May 8, 2025

(54) POSITIONING REFERENCE SIGNAL PRS MEASUREMENT METHOD, TERMINAL, AND NETWORK SIDE DEVICE

(71) Applicant: VIVO MOBILE COMMUNICATION CO., LTD., Dongguan (CN)

(72) Inventors: Wenkuan QU, Dongguan (CN); Qian YANG, Dongguan (CN); Yuanyuan WANG, Dongguan (CN); Ye SI, Dongguan (CN); Minhua ZHENG, Dongguan (CN)

(73) Assignee: VIVO MOBILE COMMUNICATION CO., LTD., Dongguan (CN)

(21) Appl. No.: 19/017,939

(22) Filed: Jan. 13, 2025

Related U.S. Application Data
(63) Continuation of application No. PCT/CN2023/106043, filed on Jul. 6, 2023.

(30) Foreign Application Priority Data
Jul. 11, 2022 (CN) 202210815562.6

(51) Int. Cl. H04W 64/00; G01S 13/76; H04W 24/10; H04W 72/044

(52) U.S. Cl. CPC H04W 64/00; G01S 13/765; H04W 24/10; H04W 72/044

(57) ABSTRACT

A positioning reference signal (PRS) measurement method, a terminal, and a network side device are provided. The positioning reference signal (PRS) measurement method includes: The terminal performs PRS measurement on at least one of a plurality of carriers to obtain a positioning measurement result when the terminal is configured to simultaneously perform PRS measurement on the plurality of carriers, where the positioning measurement result is used for positioning the terminal.

### CROSS-REFERENCE TO RELATED APPLICATIONS

This application is a continuation of International Application No. PCT/CN2023/106043, filed Jul. 6, 2023, which claims priority to Chinese Patent Application No. 202210815562.6, filed Jul. 11, 2022. The entire contents of each of the above-referenced applications are expressly incorporated herein by reference.

### TECHNICAL FIELD

This application relates to the field of communication technologies, and in particular, to a positioning reference signal PRS measurement method, a terminal, and a network side device.

### BACKGROUND

In a wireless communication system, a Positioning Reference Signal (PRS) is a reference signal that assists in positioning a terminal.

In the related art, due to a limited capability, a terminal can receive a PRS on only one carrier at a time. The received PRS on the carrier is measured, and a positioning measurement result obtained through the measurement is used for positioning the terminal.

With the development of communication technologies, if a terminal can simultaneously receive PRSs on a plurality of carriers at a time, a measurement method for applying the PRSs on the plurality of carriers to terminal positioning is urgently needed.

### SUMMARY

Embodiments of this application provide a positioning reference signal PRS measurement method, a terminal, and a network side device, which can implement a measurement method for applying PRSs on a plurality of carriers to terminal positioning.

According to a first aspect, a positioning reference signal PRS measurement method is provided, applied to a terminal, and the method includes:

The terminal performs PRS measurement on at least one of a plurality of carriers to obtain a positioning measurement result in a case that the terminal is capable of simultaneously performing PRS measurement on the plurality of carriers, where the positioning measurement result is used for positioning the terminal.

According to a second aspect, a positioning reference signal PRS measurement method is provided, applied to a network side device, and the method includes:

The network side device receives a positioning measurement result sent by a terminal, where the positioning measurement result is a result obtained by performing PRS measurement on at least one of a plurality of carriers in a case that the terminal is capable of simultaneously performing PRS measurement on the plurality of carriers.

The network side device positions the terminal based on the positioning measurement result.

According to a third aspect, a positioning reference signal PRS measurement apparatus is provided, and the apparatus includes:
a first measurement module, configured to perform PRS measurement on at least one of a plurality of carriers to obtain a positioning measurement result in a case that a terminal is capable of simultaneously performing PRS measurement on the plurality of carriers, where the positioning measurement result is used for positioning the terminal.

According to a fourth aspect, a positioning reference signal PRS measurement apparatus is provided, and the apparatus includes:
a first receiving module, configured to receive a positioning measurement result sent by a terminal, where the positioning measurement result is a result obtained by performing PRS measurement on at least one of a plurality of carriers in a case that the terminal is capable of simultaneously performing PRS measurement on the plurality of carriers; and
a first positioning module, configured to position the terminal based on the positioning measurement result.

According to a fifth aspect, a terminal is provided, where the terminal includes a processor and a memory, the memory stores a program or an instruction runnable on the processor, and the program or the instruction, when executed by the processor, implements the steps of the method according to the first aspect.

According to a sixth aspect, a terminal is provided, including a processor and a communication interface. The processor is configured to perform PRS measurement on at least one of a plurality of carriers to obtain a positioning measurement result in a case that the terminal is capable of simultaneously performing PRS measurement on the plurality of carriers, where the positioning measurement result is used for positioning the terminal.

According to a seventh aspect, a network side device is provided, where the network side device includes a processor and a memory, the memory stores a program or an instruction runnable on the processor, and the program or the instruction, when executed by the processor, implements the steps of the method according to the second aspect.

According to an eighth aspect, a network side device is provided, including a processor and a communication interface. The communication interface is configured to receive a positioning measurement result sent by a terminal. The positioning measurement result is a result obtained by performing PRS measurement on at least one of a plurality of carriers in a case that the terminal is capable of simultaneously performing PRS measurement on the plurality of carriers. The processor is configured to position the terminal based on the positioning measurement result.

According to a ninth aspect, a positioning reference signal PRS measurement system is provided, including: a terminal and a network side device. The terminal may be configured to perform the steps of the positioning reference signal PRS measurement method according to the first aspect. The network side device may be configured to perform the steps of the positioning reference signal PRS measurement method according to the second aspect.

According a tenth aspect, a readable storage medium is provided, where the readable storage medium stores a program or an instruction, and the program or the instruction, when executed by a processor, implements the steps of the method according to the first aspect, or the steps of the method according to the second aspect.

According to an eleventh aspect, a chip is provided, where the chip includes a processor and a communication interface, the communication interface is coupled to the processor, and the processor is configured to run a program or an instruction to implement the method according to the first aspect or the method according to the second aspect.

According to a twelfth aspect, a computer program/program product is provided, where the computer program/program product is stored in a storage medium, and the computer program/program product is executed by at least one processor to implement the steps of the method according to the first aspect or the steps of the method according to the second aspect.

In the embodiments of this application, in a case that a terminal has a capability of simultaneously performing PRS measurement on a plurality of carriers, the terminal performs PRS measurement on at least one of the plurality of carriers, and the positioning measurement result obtained through measurement is used for positioning the terminal. This implements a measurement method for applying PRSs on a plurality of carriers to terminal positioning.

### BRIEF DESCRIPTION OF THE DRAWINGS

FIG. 1 is a schematic diagram of a wireless communication system to which an embodiment of this application is applicable;

FIG. 2 is a first schematic flowchart of a positioning reference signal PRS measurement method according to an embodiment of this application;

FIG. 3 is a second schematic flowchart of a positioning reference signal PRS measurement method according to an embodiment of this application;

FIG. 4 is a third schematic flowchart of a positioning reference signal PRS measurement method according to an embodiment of this application;

FIG. 5 is a fourth schematic flowchart of a positioning reference signal PRS measurement method according to an embodiment of this application;

FIG. 6 is a fifth schematic flowchart of a positioning reference signal PRS measurement method according to an embodiment of this application;

FIG. 7 is a sixth schematic flowchart of a positioning reference signal PRS measurement method according to an embodiment of this application;

FIG. 8 is a first schematic structural diagram of a positioning reference signal PRS measurement apparatus according to an embodiment of this application;

FIG. 9 is a second schematic structural diagram of a positioning reference signal PRS measurement apparatus according to an embodiment of this application;

FIG. 10 is a schematic structural diagram of a communication device according to an embodiment of this application;

FIG. 11 is a schematic diagram of a hardware structure of a terminal according to an embodiment of this application; and

FIG. 12 is a schematic structural diagram of a network side device according to an embodiment of this application.

### DETAILED DESCRIPTION

Technical solutions in embodiments of this application are clearly described in the following with reference to the accompanying drawings in the embodiments of this application. Apparently, the described embodiments are some rather than all of the embodiments of this application. All other embodiments obtained by a person of ordinary skill in the art based on the embodiments of this application fall within the protection scope of this application.

The terms “first”, “second”, and so on in this specification and claims of this application are intended to distinguish between similar objects but are not intended to describe a specific order or sequence. It should be understood that the terms used in such a way are interchangeable in proper circumstances, so that the embodiments of this application can be implemented in other sequences than those illustrated or described herein. In addition, the objects distinguished by “first” and “second” are usually of one type, and there is no limitation on quantities of the objects. For example, there may be one or more first objects. In addition, “and/or” in this specification and the claims indicate at least one of the connected objects, and the character “/” usually indicates an “or” relationship between the associated objects.

It should be noted that, the technologies described in the embodiments of this application are not limited to a Long Term Evolution (LTE)/LTE-Advanced (LTE-A) system, and can be further used in other wireless communication systems, such as Code Division Multiple Address (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are often used interchangeably, and the described technologies can be used not only for the above-mentioned systems and radio technologies, but also for other systems and radio technologies. The following descriptions describe a New Radio (NR) system for exemplary purposes, and NR terms are used in most of the following descriptions. However, these technologies are also applicable to applications other than the NR system application, such as a 6th Generation (6G) communication system.

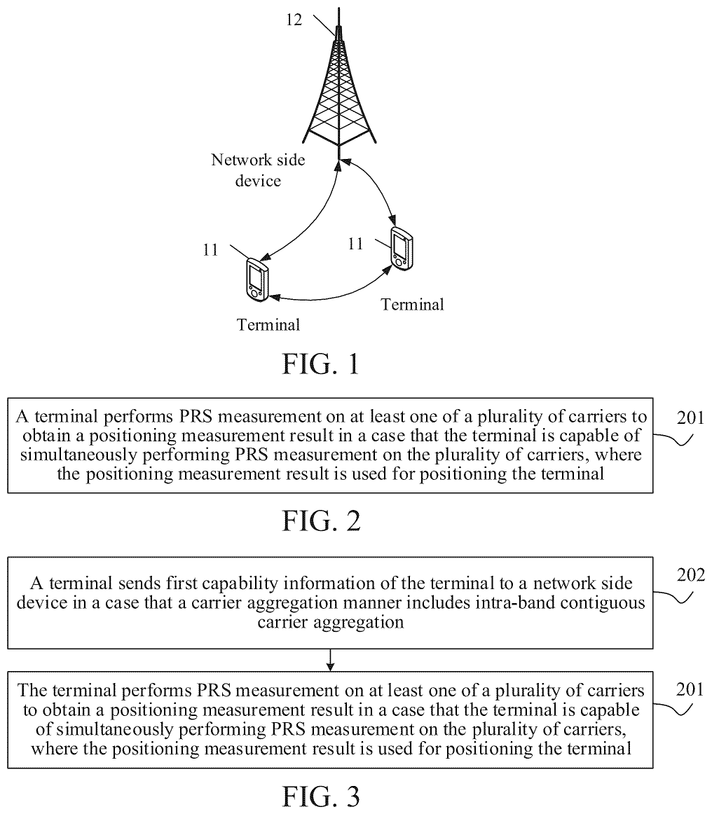

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer (or referred to as a notebook computer), a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicular user equipment (VUE), pedestrian user equipment (PUE), a smart home (a home device having a wireless communication function, such as a refrigerator, a television, a washing machine, or furniture), a game console, a personal computer (PC), a teller machine or a self-service machine, and other terminal-side devices. The wearable device includes a smartwatch, a smart band, a smart headphone, smart glasses, smart jewelry (a smart bracelet, a smart wrist-band, a smart ring, a smart necklace, a smart anklet, a smart ankle chain, and the like), a smart wrist strap, smart clothes, and the like. It should be noted that a specific type of the terminal 11 is not limited in this embodiment of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission/Reception Point (TRP), or some other suitable term in the art. As long as the same technical effect is achieved, the base station is not limited to a specific technical term. It should be noted that in this embodiment of this application, only a base station in an NR system is used as an example for description, and a specific type of the base station is not limited.

A positioning reference signal PRS measurement method provided in the embodiments of this application is described in detail below through some embodiments and application scenarios thereof with reference to the accompanying drawings.

FIG. 2 is a first schematic flowchart of a positioning reference signal PRS measurement method according to an embodiment of this application. As shown in FIG. 2, the method includes the following step 201:

Step 201: A terminal performs PRS measurement on at least one of a plurality of carriers to obtain a positioning measurement result in a case that the terminal is capable of simultaneously performing PRS measurement on the plurality of carriers, where the positioning measurement result is used for positioning the terminal.

For example, when the terminal has a capability of simultaneously performing PRS measurement on a plurality of carriers, the network side device may configure the PRSs on the plurality of carriers for the terminal. When receiving the PRSs on the plurality of carriers, the terminal may select one carrier based on parameters of each carrier, and perform PRS measurement on the one carrier, to obtain a positioning measurement result; or measure a received PRS on each carrier, and determine, based on a measurement result corresponding to the PRS on the each carrier, a positioning measurement result finally used for positioning the terminal; or combine the received PRSs on the plurality of carriers, and measure the combined PRSs to obtain a positioning measurement result.

In some embodiments, the positioning measurement result includes at least one of the following:
a Reference Signal Time Difference (RSTD); a receiving and sending time difference between receiving a PRS and sending an uplink reference signal by the terminal; Positioning Reference Signal-Reference Signal Received Power (PRS-RSRP); Positioning Reference Signal-Reference Signal Received Path Power (PRS-RSRPP); or a Carrier Phase.

The RSTD is a difference between a reference Transmission/Reception Point (TRP) and a measured TRP.

According to the positioning reference signal PRS measurement method provided in this embodiment of this application, when the terminal has a capability of simultaneously performing PRS measurement on a plurality of carriers, the terminal performs PRS measurement on at least one of the plurality of carriers, and a positioning measurement result obtained through measurement is used for positioning the terminal. This implements a measurement method for applying PRSs on a plurality of carriers to terminal positioning.

In some embodiments, carrier aggregation of the plurality of carriers includes one of the following:
intra-band contiguous carrier aggregation (Intra-band contiguous CA);
intra-band non-contiguous carrier aggregation (Intra-band non-contiguous CA); or
inter-band carrier aggregation (Inter-band CA).

In the intra-band contiguous carrier aggregation, the plurality of carriers are continuous in a same frequency band, a same radio frequency module may be used to receive PRSs on the plurality of carriers, the terminal transmits and receives data by using a single Baseband (BB) or a Radio Frequency (RF) link, and phase continuity may be ensured between the carriers. In the intra-band non-contiguous carrier aggregation or the inter-band carrier aggregation, the plurality of carriers are in different frequency bands or in a same frequency band but are not continuous between carriers, and a plurality of radio frequency modules need to be used to receive PRSs on the plurality of carriers. The terminal transmits and receives data by using a plurality of BB/RF links. The terminal converts the data received through the plurality of links into a frequency domain for splicing, and then performs positioning measurement calculation.

In some embodiments, the carrier aggregation includes a carrier aggregation manner in a first frequency band or a carrier aggregation manner in a second frequency band; and a frequency of the first frequency band is less than a frequency of the second frequency band.

The first frequency band is FR1, and a frequency range of FR1 is 450 MHz (megahertz) to 6 GHz (gigahertz). The second frequency band is FR2, and a frequency range of FR2 is 24 GHz to 52 GHz. A wavelength of an electromagnetic wave in this spectrum is most of millimeter-level.

In some embodiments, in a case that the carrier aggregation includes the intra-band contiguous carrier aggregation, a PRS on each carrier meets at least one of the following:
having a same subcarrier spacing (SCS);
having a same cyclic prefix (CP) type;
having a same reference point;
having a same PRS periodicity;
having a same slot offset within a PRS periodicity;
having a same PRS resource repetition factor;
having a same System Frame Number (SFN);
being in a same slot;
being on a same symbol;
having a same comb size; or
having a same PRS sequence.

The reference point may be a Point A.

For example, in a case that the carrier aggregation includes the intra-band contiguous carrier aggregation, when configuring a PRS on each carrier, the network side device needs to ensure that the PRS on each carrier meets at least one of the following: having a same subcarrier spacing SCS, having a same cyclic prefix CP type, having a same reference point, having a same PRS periodicity, having a same slot offset within a PRS periodicity, having a same PRS resource repetition factor, having a same system frame number SFN, being in a same slot, being on a same symbol, having a same comb size, and having a same PRS sequence. In this way, the terminal may use a same radio frequency module to receive and parse the PRS on each carrier at a same time point.

According to the positioning reference signal PRS measurement method provided in this embodiment of this application, in a case that the carrier aggregation includes the intra-band contiguous carrier aggregation, if the PRS on each carrier has one or more of the foregoing characteristics, the terminal may receive and parse the PRS on each carrier at the same time point based on the same radio frequency module. This may be applicable to a terminal configured with only one radio frequency module.

FIG. 3 is a second schematic flowchart of a positioning reference signal PRS measurement method according to an embodiment of this application. As shown in FIG. 3, before step 201, the method further includes the following step:

Step 202: The terminal sends first capability information of the terminal to a network side device in a case that the carrier aggregation includes the intra-band contiguous carrier aggregation.

The first capability information of the terminal includes at least one of the following:
a frequency band in which the terminal supports positioning by using multi-carrier aggregation;
a quantity of carriers on which the terminal supports positioning by using multi-carrier aggregation; and
a maximum bandwidth on which the terminal supports positioning by using multi-carrier aggregation.

For example, in a case that the carrier aggregation includes the intra-band contiguous carrier aggregation, if the terminal needs to receive PRSs on a plurality of carriers sent by the network side device, the terminal needs to first send first capability information of the terminal to the network side device. The first capability information includes at least one of the following: a frequency band in which the terminal supports positioning by using multi-carrier aggregation, a quantity of carriers on which the terminal supports positioning by using multi-carrier aggregation, and a maximum bandwidth on which the terminal supports positioning by using multi-carrier aggregation. This helps the network side device determine, based on the first capability information of the terminal when receiving the first capability information sent by the terminal, a quantity of carriers configured for the terminal to carry the PRSs, a frequency band of the carrier, a bandwidth, and the like, and configure the PRSs on the plurality of carriers for the terminal based on the determined quantity of carriers used for carrying the PRSs, the determined frequency band of the carrier, the determined bandwidth, and the like.

According to the positioning reference signal PRS measurement method provided in this embodiment of this application, in a case that the carrier aggregation includes the intra-band contiguous carrier aggregation, the terminal first sends the first capability information of the terminal to the network side device, so that the network side device configures PRSs on a plurality of carriers for the terminal based on the first capability information of the terminal. This avoids a case that the terminal is incapable of processing the PRSs on the plurality of carriers configured by the network side device, thereby achieving proper utilization of resources.

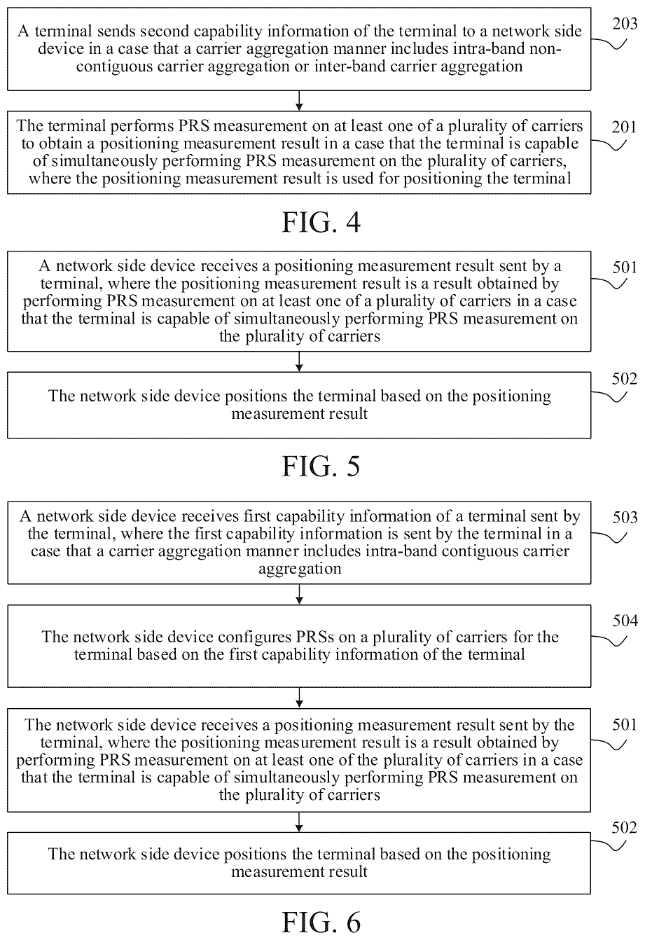

FIG. 4 is a third schematic flowchart of a positioning reference signal PRS measurement method according to an embodiment of this application. As shown in FIG. 4, before step 201, the method further includes the following step:

Step 203: The terminal sends second capability information of the terminal to a network side device in a case that the carrier aggregation includes the intra-band non-contiguous carrier aggregation or the inter-band carrier aggregation.

The second capability information of the terminal includes at least one of the following:
a frequency band in which the terminal supports positioning by using multi-carrier aggregation;
a quantity of carriers on which the terminal supports positioning by using multi-carrier aggregation;
a maximum bandwidth on which the terminal supports positioning by using multi-carrier aggregation;
a timing difference (timing error) between carriers;
a frequency difference (frequency error) between carriers;
a phase difference (phase error) between carriers; and
a power difference between carriers.

For example, in a case that the carrier aggregation includes the intra-band non-contiguous carrier aggregation or the inter-band carrier aggregation, because the plurality of carriers are in different frequency bands, or are discontinuous in a same frequency band, a plurality of radio frequency modules need to be used to receive the PRSs on the plurality of carriers. Therefore, in this case, a timing difference between every two carriers, a frequency difference between every two carriers, a phase difference between every two carriers, and a power difference between every two carriers in the plurality of carriers need to be determined. Then, the second capability information of the terminal is sent to the network side device. The second capability information includes at least one of the following: a frequency band in which the terminal supports positioning by using multi-carrier aggregation, a quantity of carriers on which the terminal supports positioning by using multi-carrier aggregation, a maximum bandwidth on which the terminal supports positioning by using multi-carrier aggregation, a timing difference between carriers, a frequency difference between carriers, a phase difference between carriers, and a power difference between carriers. This helps the network side device determine, based on the second capability information of the terminal when receiving the second capability information sent by the terminal, a quantity of carriers configured for the terminal to carry the PRSs, a frequency band of the carrier, a bandwidth, and the like, and configure the PRSs on the plurality of carriers for the terminal based on the determined quantity of carriers used for carrying the PRSs, the determined frequency band of the carrier, the determined bandwidth, and the like.

It should be noted that when the network side device determines, based on the second capability information of the terminal, a quantity of carriers configured for the terminal to carry the PRSs, a frequency band of the carrier, a bandwidth, and the like, the network side device determines them based on at least one of the frequency band in which the terminal supports positioning by using multi-carrier aggregation, the quantity of carriers on which the terminal supports positioning by using multi-carrier aggregation, and the maximum bandwidth on which the terminal supports positioning by using multi-carrier aggregation in the second capability information. The timing difference between carriers, the frequency difference between carriers, the phase difference between carriers, and the power difference between carriers in the second capability information are used for determining precision of the received positioning measurement result.

According to the positioning reference signal PRS measurement method provided in this embodiment of this application, in a case that the carrier aggregation includes the intra-band non-contiguous carrier aggregation or the inter-band carrier aggregation, the terminal first sends the second capability information of the terminal to the network side device, so that the network side device configures PRSs on a plurality of carriers for the terminal based on the second capability information of the terminal. This avoids a case that the terminal is incapable of processing the PRSs on the plurality of carriers configured by the network side device, thereby achieving proper utilization of resources.

In some embodiments, the at least one carrier is more than one carrier. In a case that the carrier aggregation includes the intra-band non-contiguous carrier aggregation or the inter-band carrier aggregation, that the terminal performs PRS measurement on at least one of the plurality of carriers to obtain a positioning measurement result may be implemented in the following manners:

The terminal performs PRS measurement on a plurality of carriers that do not meet at least one of the following conditions, to obtain the positioning measurement result:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

The first threshold is a maximum timing difference allowed between the carriers. The second threshold is a maximum frequency difference allowed between the carriers. The third threshold is a maximum phase difference allowed between the carriers. The fourth threshold is a maximum power difference allowed between the carriers.

The maximum timing difference allowed is a set maximum timing difference that satisfies positioning precision. The maximum frequency difference allowed is a set maximum frequency difference that satisfies positioning precision. The maximum phase difference allowed is a set maximum phase difference that satisfies positioning precision. The maximum power difference allowed is a set maximum power difference that satisfies positioning precision.

For example, when intending to simultaneously measure PRSs on a plurality of carriers, the terminal may first compare a timing difference between every two carriers in the plurality of carriers with the first threshold, compare a frequency difference between every two carriers with the second threshold, compare a phase difference between every two carriers with the third threshold, and compare a power difference between every two carriers with the fourth threshold. If at least one of the following conditions is not met: a timing difference between the carriers is greater than or equal to the first threshold, a frequency difference between the carriers is greater than or equal to the second threshold, a phase difference between the carriers is greater than or equal to the third threshold, or a power difference between the carriers is greater than or equal to the fourth threshold, it indicates that the terminal may perform joint measurement on the PRSs on the plurality of carriers, that is, combine the PRSs on the plurality of carriers and measure the combined PRSs, to obtain the positioning measurement result.

It should be noted that when the carrier aggregation includes the intra-band non-contiguous carrier aggregation or the inter-band carrier aggregation, the terminal may receive PRSs on a plurality of carriers at different time points, combine the PRSs on the plurality of carriers when all the PRSs on the plurality of carriers are received, and measure the combined PRSs. Because the PRSs on the plurality of carriers do not need to be received simultaneously, there is no need to restrict the PRSs on all the carriers to have a same SCS, have a same CP type, have a same reference point, have a same PRS periodicity, have a same slot offset within a PRS periodicity, have a same PRS resource repetition factor, have a same system frame number, be in a same slot, be on a same symbol, have a same comb size, have a same PRS sequence, or the like.

According to the positioning reference signal PRS measurement method provided in this embodiment of this application, in a case that the carrier aggregation includes the intra-band non-contiguous carrier aggregation or the inter-band carrier aggregation, when at least one of the following conditions is not met: a timing difference between carriers is greater than or equal to the first threshold, a frequency difference between carriers is greater than or equal to the second threshold, a phase difference between carriers is greater than or equal to the third threshold, and a power difference between carriers is greater than or equal to the fourth threshold, the terminal performs joint measurement on PRSs on a plurality of carriers that do not meet the at least one condition, to obtain the positioning measurement result, so as to improve precision of the positioning measurement result.

In some embodiments, the at least one carrier is more than one carrier. In a case that the carrier aggregation includes the intra-band non-contiguous carrier aggregation or the inter-band carrier aggregation, the method further includes:

The terminal skips performing PRS measurement on a plurality of carriers that meet at least one of the following conditions. In some embodiments, the terminal performs PRS measurement on a plurality of carriers that meet at least one of the following conditions, to obtain the positioning measurement result, where the positioning measurement result is not used for positioning the terminal:
a timing difference between the carriers is greater than or equal to the first threshold;
a frequency difference between the carriers is greater than or equal to the second threshold;
a phase difference between the carriers is greater than or equal to the third threshold; and
a power difference between the carriers is greater than or equal to the fourth threshold.

The first threshold is a maximum timing difference allowed between the carriers. The second threshold is a maximum frequency difference allowed between the carriers. The third threshold is a maximum phase difference allowed between the carriers. The fourth threshold is a maximum power difference allowed between the carriers.

For example, if at least one of the following conditions is met: the timing difference between the carriers is greater than or equal to the first threshold, the frequency difference between the carriers is greater than or equal to the second threshold, the phase difference between the carriers is greater than or equal to the third threshold, and the power difference between the carriers is greater than or equal to the fourth threshold, it indicates that the precision of the positioning measurement result obtained by jointly measuring the PRSs on the plurality of carriers is relatively low. In this case, the terminal may not measure PRSs on the plurality of carriers that meet the at least one condition, and consequently, no positioning measurement result is obtained.

In some embodiments, the terminal may perform joint measurement on PRSs on the plurality of carriers that meet the at least one condition, that is, combine the PRSs on the plurality of carriers and measure the combined PRSs to obtain the positioning measurement result, and send the positioning measurement result to the network side device. However, the network side device may determine, based on the previously received second capability information of the terminal (the timing difference between the carriers is greater than or equal to the first threshold, the frequency difference between the carriers is greater than or equal to the second threshold, the phase difference between the carriers is greater than or equal to the third threshold, or the power difference between the carriers is greater than or equal to the fourth threshold), that the precision of the positioning measurement result sent by the terminal is relatively low. Even if the positioning measurement result is received, the terminal is not positioned based on the received positioning measurement result.

According to the positioning reference signal PRS measurement method provided in this embodiment of this application, in a case that the carrier aggregation includes the intra-band non-contiguous carrier aggregation or the inter-band carrier aggregation, if at least one of the following conditions is met: the timing difference between the carriers is greater than or equal to the first threshold, the frequency difference between the carriers is greater than or equal to the second threshold, the phase difference between the carriers is greater than or equal to the third threshold, and the power difference between the carriers is greater than or equal to the fourth threshold, the terminal may not perform PRS measurement on a plurality of carriers that meet the at least one condition, and consequently, no positioning measurement result is obtained. In this case, there is no need to send a positioning measurement result to the network side device, thereby saving network resources.

In some embodiments, that the terminal performs PRS measurement on the at least one of the plurality of carriers may be implemented in the following two manners:

In a first manner, for each of the carrier aggregations, the terminal performs PRS measurement on one of the plurality of carriers to obtain the positioning measurement result.

In some embodiments, the terminal performs PRS measurement on the one of the plurality of carriers based on at least one of the following parameters: a subcarrier spacing SCS, a bandwidth, a signal-to-noise ratio (SNR), and a total quantity of PRS resources.

For example, for any carrier aggregation manner in the intra-band contiguous carrier aggregation, the intra-band non-contiguous carrier aggregation, and the inter-band carrier aggregation, the terminal may perform PRS measurement on one of the plurality of carriers based on at least one of the following parameters of each carrier: a subcarrier spacing SCS, a bandwidth, a signal-to-noise ratio, and a total quantity of PRS resources, and directly use an obtained measurement result as the positioning measurement result. In some embodiments, which carrier is selected from the plurality of carriers may be determined by the terminal. This is not limited in this application. Values of the foregoing four parameters: the subcarrier spacing SCS, the bandwidth, the signal-to-noise ratio, and the total quantity of PRS resources, all affect measurement precision of the PRS. Larger values of the parameters indicate higher PRS measurement precision. For example, it is assumed that the plurality of carriers include a carrier 1 and a carrier 2, an SCS of the carrier 1 is 40 KHZ (kilohertz), and an SCS of the carrier 2 is 20 KHZ. In this case, PRS measurement is performed on the carrier 1.

In a second manner, for each of the carrier aggregations, the terminal performs PRS measurement on the plurality of carriers to obtain a measurement result corresponding to each PRS, and determines the positioning measurement result based on a measurement result corresponding to at least one of the plurality of PRSs.

In some embodiments, the terminal performs PRS measurement on the one of the plurality of carriers based on at least one of the following parameters: a subcarrier spacing SCS, a bandwidth, a signal-to-noise ratio, and a total quantity of PRS resources.

For example, for any carrier aggregation manner in the intra-band contiguous carrier aggregation, the intra-band non-contiguous carrier aggregation, and the inter-band carrier aggregation, the terminal may perform PRS measurement on one of the plurality of carriers, and directly use an obtained measurement result as the positioning measurement result. In some embodiments, the terminal separately performs PRS measurement on a plurality of carriers to obtain a measurement result corresponding to each PRS, and then selects a measurement result with relatively high precision from the measurement results corresponding to all the PRSs as the positioning measurement result, or averages or weights the measurement results corresponding to all the PRSs to obtain the positioning measurement result.

According to the positioning reference signal PRS measurement method provided in this embodiment of this application, the terminal may perform PRS measurement on one of a plurality of carriers, and directly use an obtained measurement result as a positioning measurement result. The measurement is simple and time-saving. In some embodiments, the terminal may separately measure PRSs on a plurality of carriers, and then select a measurement result with relatively high precision from measurement results corresponding to all the PRSs as a positioning measurement result, or average or weight measurement results corresponding to all the PRSs to obtain a positioning measurement result. This improves precision of the positioning measurement result and further improves precision of positioning the terminal based on the positioning measurement result.

In some embodiments, the total quantity of PRS resources is determined based on the following parameters: a PRS resource repetition factor, a quantity of symbols occupied by the PRS resource, and a comb size of the PRS resource.

For example, the total quantity of PRS resources is determined based on the following formula (1):

$$the total quantity of PRS resources = {T}_{rep}^{PRS} * {L}_{PRS} / {K}_{comb}^{PRS} \qquad ( 1 )$$

where Tᵣₑₚ^{PRS} represents the PRS resource repetition factor, L_{PRS} represents the quantity of symbols occupied by the PRS resource, and K_{comb}^{PRS} represents the comb size of the PRS resource.

In some embodiments, that the terminal performs PRS measurement on the at least one of the plurality of carriers may be further implemented in the following manner:

The terminal performs PRS measurement on the at least one of the plurality of carriers during PRS measurement time.

The PRS measurement time is determined based on the following parameters: a PRS periodicity, a duration of an available PRS resource, and a maximum quantity of PRS resources in a slot. The PRS periodicity is a least common multiple of PRS periodicities on all carriers. The duration of the available PRS resource is a largest value among durations of PRS resources on all carriers. The maximum quantity of PRS resources in the slot is a largest value among quantities of PRS resources in all slots on all carriers.

For example, the terminal needs to complete measurement of the PRS on the at least one of the plurality of carriers within preset PRS measurement time, for example, measurement time corresponding to the RSTD, measurement time corresponding to the receiving and sending time difference, measurement time corresponding to the PRS-RSRP, measurement time corresponding to the PRS-RSRPP, and measurement time corresponding to the carrier phase. It is required to complete the measurement of the corresponding parameter within the measurement time, and particular measurement precision further needs to be ensured.

According to the positioning reference signal PRS measurement method provided in this embodiment of this application, the terminal may perform PRS measurement on at least one of a plurality of carriers during PRS measurement time, so as to ensure measurement validity.

In some embodiments, after step 201, the method further include the following step:
sending, by the terminal, the positioning measurement result to the network side device.

FIG. 5 is a fourth schematic flowchart of a positioning reference signal PRS measurement method according to an embodiment of this application. As shown in FIG. 5, the method includes the following step 501 and step 502:

Step 501: A network side device receives a positioning measurement result sent by a terminal, where the positioning measurement result is a result obtained by performing PRS measurement on at least one of a plurality of carriers in a case that the terminal is capable of simultaneously performing PRS measurement on the plurality of carriers.

Step 502: The network side device positions the terminal based on the positioning measurement result.

According to the positioning reference signal PRS measurement method provided in this embodiment of this application, in a case that the terminal has a capability of simultaneously performing PRS measurement on a plurality of carriers, the terminal performs PRS measurement on at least one of the plurality of carriers, and a positioning measurement result obtained through measurement is used for positioning the terminal. This implements a measurement method for applying PRSs on a plurality of carriers to terminal positioning.

In some embodiments, the positioning measurement result includes at least one of the following:
a reference signal time difference RSTD;
a receiving and sending time difference between receiving a PRS and sending an uplink reference signal by the terminal;
positioning reference signal-reference signal received power PRS-RSRP;
positioning reference signal-reference signal received path power PRS-RSRPP; or
a carrier phase.

In some embodiments, carrier aggregation of the plurality of carriers includes one of the following:
intra-band contiguous carrier aggregation;
intra-band non-contiguous carrier aggregation; or
inter-band carrier aggregation.

In some embodiments, the carrier aggregation includes a carrier aggregation manner in a first frequency band or a carrier aggregation manner in a second frequency band; and a frequency of the first frequency band is less than a frequency of the second frequency band.

FIG. 6 is a fifth schematic flowchart of a positioning reference signal PRS measurement method according to an embodiment of this application. As shown in FIG. 6, before step 501, the method further includes the following steps:

Step 503: The network side device receives first capability information of the terminal sent by the terminal, where the first capability information is sent by the terminal in a case that the carrier aggregation includes the intra-band contiguous carrier aggregation.

Step 504: The network side device configures PRSs on the plurality of carriers for the terminal based on the first capability information of the terminal.

The first capability information of the terminal includes at least one of the following: a frequency band in which the terminal supports positioning by using multi-carrier aggregation; a quantity of carriers on which the terminal supports positioning by using multi-carrier aggregation; and a maximum bandwidth on which the terminal supports positioning by using multi-carrier aggregation.

In some embodiments, the configuring, by the network side device, the PRSs on the plurality of carriers for the terminal based on the first capability information of the terminal meets at least one of the following:
having a same subcarrier spacing SCS;
having a same cyclic prefix CP type;
having a same reference point;
having a same PRS periodicity;
having a same slot offset within a PRS periodicity;
having a same PRS resource repetition factor;
having a same system frame number SFN;
being in a same slot;
being on a same symbol;
having a same comb size; or
having a same PRS sequence.

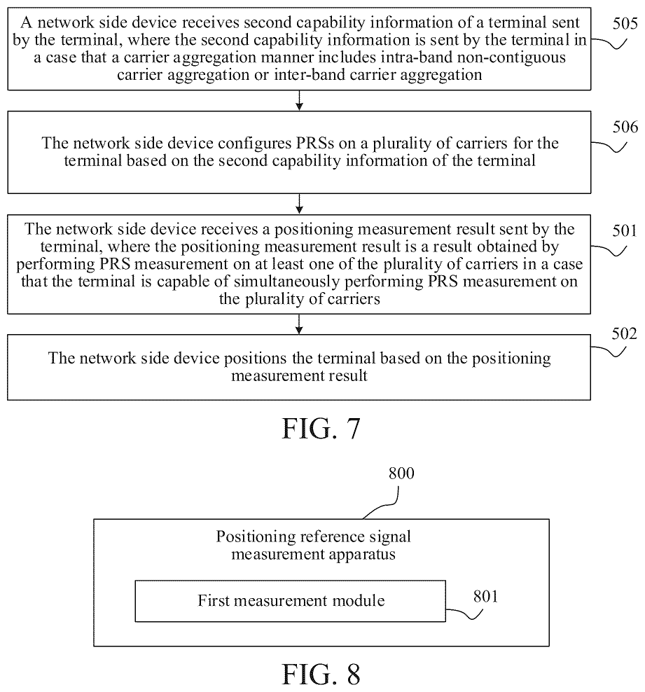

FIG. 7 is a sixth schematic flowchart of a positioning reference signal PRS measurement method according to an embodiment of this application. As shown in FIG. 7, before step 501, the method further includes the following steps:

Step 505: The network side device receives second capability information of the terminal sent by the terminal, where the second capability information is sent by the terminal in a case that the carrier aggregation includes the intra-band non-contiguous carrier aggregation or the inter-band carrier aggregation.

Step 506: The network side device configures PRSs on the plurality of carriers for the terminal based on the second capability information of the terminal.

The second capability information of the terminal includes at least one of the following: a frequency band in which the terminal supports positioning by using multi-carrier aggregation; a quantity of carriers on which the terminal supports positioning by using multi-carrier aggregation; a maximum bandwidth on which the terminal supports positioning by using multi-carrier aggregation; a timing difference between carriers; a frequency difference between carriers; a phase difference between carriers; or a power difference between carriers.

In some embodiments, that the network side device positions the terminal based on the positioning measurement result may be implemented in the following manner:

The network side device positions the terminal based on the positioning measurement result in a case that the positioning measurement result is a result obtained by the terminal by performing PRS measurement on a plurality of carriers that do not meet at least one of the following conditions:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

The first threshold is a maximum timing difference allowed between the carriers. The second threshold is a maximum frequency difference allowed between the carriers. The third threshold is a maximum phase difference allowed between the carriers. The fourth threshold is a maximum power difference allowed between the carriers.

In some embodiments, the method further include the following step:
skipping, by the network side device, positioning the terminal based on the positioning measurement result in a case that the positioning measurement result is a result obtained by the terminal by performing PRS measurement on a plurality of carriers that meet at least one of the following conditions:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

The first threshold is a maximum timing difference allowed between the carriers. The second threshold is a maximum frequency difference allowed between the carriers. The third threshold is a maximum phase difference allowed between the carriers. The fourth threshold is a maximum power difference allowed between the carriers.

A specific implementation process and technical effects of the method in this embodiment are the same as or similar to those in the method embodiment on the terminal side. For details, reference may be made to the detailed description in the method embodiment on the terminal side, and details are not described herein again.

The positioning reference signal PRS measurement method provided in this embodiment of this application may be performed by a positioning reference signal PRS measurement apparatus. In an embodiment of this application, the positioning reference signal PRS measurement apparatus provided in the embodiments of this application is described by using an example in which the positioning reference signal PRS measurement apparatus performs the positioning reference signal PRS measurement method.

FIG. 8 is a first schematic structural diagram of a positioning reference signal PRS measurement apparatus according to an embodiment of this application. The apparatus is applied to a terminal. As shown in FIG. 8, the positioning reference signal PRS measurement apparatus 800 includes:
a first measurement module 801, configured to perform PRS measurement on at least one of a plurality of carriers to obtain a positioning measurement result in a case that the terminal is capable of simultaneously performing PRS measurement on the plurality of carriers, where the positioning measurement result is used for positioning the terminal.

According to the positioning reference signal PRS measurement apparatus provided in this embodiment of this application, in a case that the terminal has a capability of simultaneously performing PRS measurement on a plurality of carriers, the terminal performs PRS measurement on at least one of the plurality of carriers, and a positioning measurement result obtained through measurement is used for positioning the terminal. This implements a measurement method for applying PRSs on a plurality of carriers to terminal positioning.

In some embodiments, the positioning measurement result includes at least one of the following:
a reference signal time difference RSTD;
a receiving and sending time difference between receiving a PRS and sending an uplink reference signal by the terminal;
positioning reference signal-reference signal received power PRS-RSRP;
positioning reference signal-reference signal received path power PRS-RSRPP; or
a carrier phase.

In some embodiments, carrier aggregation of the plurality of carriers includes one of the following:
intra-band contiguous carrier aggregation;
intra-band non-contiguous carrier aggregation; or
inter-band carrier aggregation.

In some embodiments, the carrier aggregation includes a carrier aggregation manner in a first frequency band or a carrier aggregation manner in a second frequency band; and a frequency of the first frequency band is less than a frequency of the second frequency band.

In some embodiments, in a case that the carrier aggregation includes the intra-band contiguous carrier aggregation, a PRS on each carrier meets at least one of the following:
having a same subcarrier spacing SCS;
having a same cyclic prefix CP type;
having a same reference point;
having a same PRS periodicity;
having a same slot offset within a PRS periodicity;
having a same PRS resource repetition factor;
having a same system frame number SFN;
being in a same slot;
being on a same symbol;
having a same comb size; or
having a same PRS sequence.

In some embodiments, the positioning reference signal PRS measurement apparatus 800 further includes:
a first sending module, configured to send first capability information of the terminal to a network side device in a case that the carrier aggregation includes the intra-band contiguous carrier aggregation.

The first capability information of the terminal includes at least one of the following:
a frequency band in which the terminal supports positioning by using multi-carrier aggregation;
a quantity of carriers on which the terminal supports positioning by using multi-carrier aggregation; and
a maximum bandwidth on which the terminal supports positioning by using multi-carrier aggregation.

In some embodiments, the positioning reference signal PRS measurement apparatus 800 further includes:
a second sending module, configured to send second capability information of the terminal to a network side device in a case that the carrier aggregation includes the intra-band non-contiguous carrier aggregation or the inter-band carrier aggregation.

The second capability information of the terminal includes at least one of the following:
a frequency band in which the terminal supports positioning by using multi-carrier aggregation;
a quantity of carriers on which the terminal supports positioning by using multi-carrier aggregation;
a maximum bandwidth on which the terminal supports positioning by using multi-carrier aggregation;
a timing difference between carriers;
a frequency difference between carriers;
a phase difference between carriers; or
a power difference between carriers.

In some embodiments, the at least one carrier is more than one carrier. The first measurement module 801 is further configured to:
perform PRS measurement on a plurality of carriers that do not meet at least one of the following conditions, to obtain the positioning measurement result:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

In some embodiments, the at least one carrier is more than one carrier. The positioning reference signal PRS measurement apparatus 800 further includes:
a second measurement module, configured to skip performing PRS measurement on a plurality of carriers that meet at least one of the following conditions, or perform PRS measurement on a plurality of carriers that meet at least one of the following conditions, to obtain the positioning measurement result, where the positioning measurement result is not used for positioning the terminal:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

In some embodiments, the first threshold is a maximum timing difference allowed between the carriers;
the second threshold is a maximum frequency difference allowed between the carriers;
the third threshold is a maximum phase difference allowed between the carriers; and
the fourth threshold is a maximum power difference allowed between the carriers.

In some embodiments, the first measurement module 801 is further configured to:
for each of the carrier aggregations, perform PRS measurement on one of the plurality of carriers to obtain the positioning measurement result; or
perform PRS measurement on the plurality of carriers to obtain a measurement result corresponding to each PRS, and determine the positioning measurement result based on a measurement result corresponding to at least one of the plurality of PRSs.

In some embodiments, the first measurement module 801 is further configured to:
perform PRS measurement on the one of the plurality of carriers based on at least one of the following parameters:
a subcarrier spacing SCS;
a bandwidth;
a signal-to-noise ratio; and
a total quantity of PRS resources.

In some embodiments, the first measurement module 801 is further configured to:
perform PRS measurement on the plurality of carriers based on at least one of the following parameters:
a subcarrier spacing SCS;
a bandwidth;
a signal-to-noise ratio; and
a total quantity of PRS resources.

In some embodiments, the total quantity of PRS resources is determined based on the following parameters:
a PRS resource repetition factor, a quantity of symbols occupied by the PRS resource, and a comb size of the PRS resource.

In some embodiments, the first measurement module 801 is further configured to:
perform PRS measurement on the at least one of the plurality of carriers during PRS measurement time.

In some embodiments, the PRS measurement time is determined based on the following parameters:
a PRS periodicity, a duration of an available PRS resource, and a maximum quantity of PRS resources in a slot.

The PRS periodicity is a least common multiple of PRS periodicities on all carriers.

The duration of the available PRS resource is a largest value among durations of PRS resources on all carriers.

The maximum quantity of PRS resources in the slot is a largest value among quantities of PRS resources in all slots on all carriers.

In some embodiments, the positioning reference signal PRS measurement apparatus 800 further includes:
a third sending module, configured to send the positioning measurement result to the network side device.

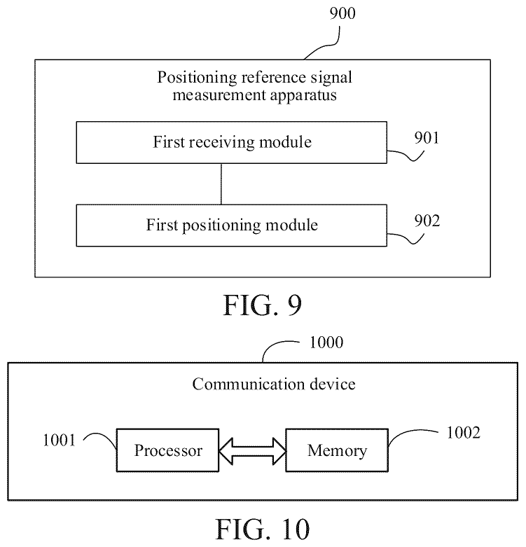

FIG. 9 is a second schematic structural diagram of a positioning reference signal PRS measurement apparatus according to an embodiment of this application. The apparatus is applied to a network side device. As shown in FIG. 9, the positioning reference signal PRS measurement apparatus 900 includes:
a first receiving module 901, configured to receive a positioning measurement result sent by a terminal, where the positioning measurement result is a result obtained by performing PRS measurement on at least one of a plurality of carriers in a case that the terminal is capable of simultaneously performing PRS measurement on the plurality of carriers; and
a first positioning module 902, configured to position the terminal based on the positioning measurement result.

According to the positioning reference signal PRS measurement apparatus provided in this embodiment of this application, in a case that the terminal has a capability of simultaneously performing PRS measurement on a plurality of carriers, the terminal performs PRS measurement on at least one of the plurality of carriers, and a positioning measurement result obtained through measurement is used for positioning the terminal. This implements a measurement method for applying PRSs on a plurality of carriers to terminal positioning.

In some embodiments, the positioning measurement result includes at least one of the following:
a reference signal time difference RSTD;
a receiving and sending time difference between receiving a PRS and sending an uplink reference signal by the terminal;
positioning reference signal-reference signal received power PRS-RSRP;
positioning reference signal-reference signal received path power PRS-RSRPP; or
a carrier phase.

In some embodiments, carrier aggregation of the plurality of carriers includes one of the following:
intra-band contiguous carrier aggregation;
intra-band non-contiguous carrier aggregation; or
inter-band carrier aggregation.

In some embodiments, the carrier aggregation includes a carrier aggregation manner in a first frequency band or a carrier aggregation manner in a second frequency band; and a frequency of the first frequency band is less than a frequency of the second frequency band.

In some embodiments, the positioning reference signal PRS measurement apparatus 900 further includes:
a second receiving module, configured to receive first capability information of the terminal sent by the terminal, where the first capability information is sent by the terminal in a case that the carrier aggregation includes the intra-band contiguous carrier aggregation; and
a first configuration module, configured to configure the PRSs on the plurality of carriers for the terminal based on the first capability information of the terminal.

The first capability information of the terminal includes at least one of the following:
a frequency band in which the terminal supports positioning by using multi-carrier aggregation;
a quantity of carriers on which the terminal supports positioning by using multi-carrier aggregation; and
a maximum bandwidth on which the terminal supports positioning by using multi-carrier aggregation.

In some embodiments, the first configuration module is further configured to:
configure the PRSs on the plurality of carriers for the terminal based on the first capability information of the terminal to meet at least one of the following:
having a same subcarrier spacing (SCS);
having a same cyclic prefix (CP) type;
having a same reference point;
having a same PRS periodicity;
having a same slot offset within a PRS periodicity;
having a same PRS resource repetition factor;
having a same system frame number SFN;
being in a same slot;
being on a same symbol;
having a same comb size; or
having a same PRS sequence.

In some embodiments, the positioning reference signal (PRS) measurement apparatus 900 further includes:
a third receiving module, configured to receive second capability information of the terminal sent by the terminal, where the second capability information is sent by the terminal in a case that the carrier aggregation includes the intra-band non-contiguous carrier aggregation or the inter-band carrier aggregation; and
a second configuration module, configured to configure the PRSs on the plurality of carriers for the terminal based on the second capability information of the terminal.

The second capability information of the terminal includes at least one of the following:
a frequency band in which the terminal supports positioning by using multi-carrier aggregation;
a quantity of carriers on which the terminal supports positioning by using multi-carrier aggregation;
a maximum bandwidth on which the terminal supports positioning by using multi-carrier aggregation;
a timing difference between carriers;
a frequency difference between carriers;
a phase difference between carriers; or
a power difference between carriers.

In some embodiments, the first positioning module 902 is further configured to:
position the terminal based on the positioning measurement result in a case that the positioning measurement result is a result obtained by the terminal by performing PRS measurement on a plurality of carriers that do not meet at least one of the following conditions:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

In some embodiments, the positioning reference signal PRS measurement apparatus 900 further includes:
a second positioning module, configured to skip positioning the terminal based on the positioning measurement result in a case that the positioning measurement result is a result obtained by the terminal by performing PRS measurement on a plurality of carriers that meet at least one of the following conditions:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

In some embodiments, the first threshold is a maximum timing difference allowed between the carriers;
the second threshold is a maximum frequency difference allowed between the carriers;
the third threshold is a maximum phase difference allowed between the carriers; and
the fourth threshold is a maximum power difference allowed between the carriers.

The positioning reference signal PRS measurement apparatus in this embodiment of this application may be an electronic device, for example, an electronic device with an operating system, or may be a component in an electronic device, for example, an integrated circuit or a chip. The electronic device may be a terminal, or may be another device other than a terminal. For example, the terminal may include, but is not limited to, the types of the terminal 11 listed above, and the another device may be a server, a Network Attached Storage (NAS), or the like. This is not specifically limited in this embodiment of this application.

The positioning reference signal PRS measurement apparatus provided in this embodiment of this application can implement the processes implemented in the method embodiments of FIG. 2 to FIG. 7 and achieve the same technical effects. To avoid repetition, details are not described herein again.

As shown in FIG. 10, an embodiment of this application further provides a communication device 1000, including a processor 1001 and a memory 1002. The memory 1002 stores a program or an instruction runnable on the processor 1001. For example, when the communication device 1000 is a terminal, the program or the instruction, when executed by the processor 1001, implements the steps of the foregoing embodiment of the positioning reference signal PRS measurement method, and the same technical effects can be achieved. When the communication device 1000 is a network side device, the program or the instruction, when executed by the processor 1001, implements the steps of the foregoing embodiment of the positioning reference signal PRS measurement method, and the same technical effects can be achieved. To avoid repetition, details are not described herein again.

An embodiment of this application further provides a terminal, including a processor and a communication interface. The processor is configured to perform PRS measurement on at least one of a plurality of carriers to obtain a positioning measurement result in a case that the terminal is capable of simultaneously performing PRS measurement on the plurality of carriers. The positioning measurement result is used for positioning the terminal. This terminal embodiment corresponds to the foregoing terminal-side method embodiment. Implementation processes and implementations of the foregoing method embodiment all may be applied to this terminal embodiment, and the same technical effects can be achieved.

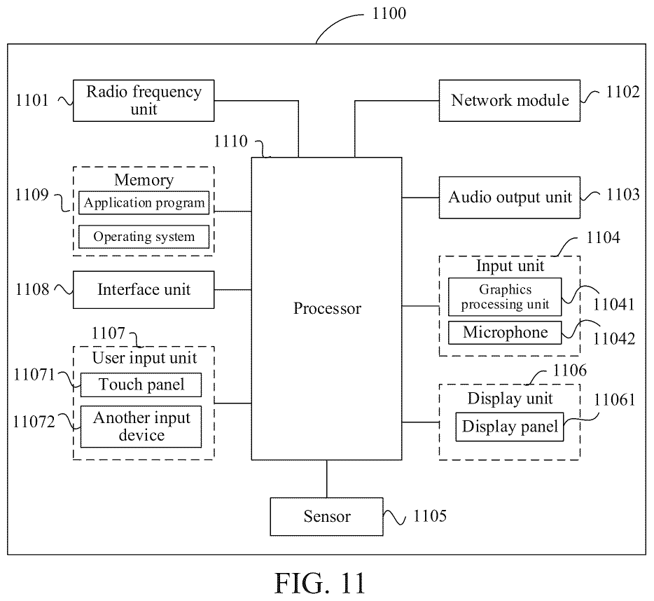

FIG. 11 is a schematic diagram of a hardware structure of a terminal that implements an embodiment of this application.

The terminal 1100 includes, but is not limited to: at least some components in a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art may understand that, the terminal 1100 may further include a power supply (such as a battery) for supplying power to each component. The power supply may be logically connected to the processor 1110 by using a power management system, thereby implementing functions, such as charging, discharging, and power consumption management, by using the power management system. The terminal structure shown in FIG. 11 constitutes no limitation on the terminal. The terminal may include more or fewer components than those shown in the figure, or some components may be combined, or a different component deployment may be used. Details are not described herein.

It should be understood that in this embodiment of this application, the input unit 1104 may include a Graphics Processing Unit (GPU) 11041 and a microphone 11042. The graphics processing unit 11041 processes image data of still pictures or videos captured by an image capture apparatus (such as a camera) in a video capture mode or an image capture mode. The display unit 1106 may include a display panel 11061. The display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include, but is not limited to, a physical keyboard, a functional button (such as a sound volume control button or a power button), a trackball, a mouse, or a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Usually, the radio frequency unit 1101 includes, but is not limited to, an antenna, an amplifier, a transceiver, a coupler, a low noise amplifier, a duplexer, and the like.

The memory 1109 may be configured to store a software program or instruction and various data. The memory 1109 may mainly include a first storage area storing a program or an instruction and a second storage area storing data. The first storage area may store an operating system, an application program or an instruction required by at least one function (for example, a sound playing function or an image playing function), and the like. In addition, the memory 1109 may include a volatile memory or a non-volatile memory, or the memory 1109 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in this embodiment of this application includes, but is not limited to, these memories and any other suitable types of memories.

The processor 1110 may include one or more processing units. In some embodiments, the processor 1110 integrates an application processor and a modem processor. The application processor mainly processes operations related to the operating system, a user interface, the application program, and the like. The modem processor mainly processes a wireless communication signal, and is, for example, a baseband processor. It may be understood that the modem processor may not be integrated in the processor 1110.

The processor 1110 is configured to perform PRS measurement on at least one of a plurality of carriers to obtain a positioning measurement result in a case that the terminal is capable of simultaneously performing PRS measurement on the plurality of carriers. The positioning measurement result is used for positioning the terminal.

In this embodiment of this application, in a case that the terminal has a capability of simultaneously performing PRS measurement on a plurality of carriers, the terminal performs PRS measurement on at least one of the plurality of carriers, and a positioning measurement result obtained through measurement is used for positioning the terminal. This implements a measurement method for applying PRSs on a plurality of carriers terminal positioning.

In some embodiments, the positioning measurement result includes at least one of the following:
a reference signal time difference RSTD;
a receiving and sending time difference between receiving a PRS and sending an uplink reference signal by the terminal;
positioning reference signal-reference signal received power PRS-RSRP;
positioning reference signal-reference signal received path power PRS-RSRPP; or
a carrier phase.

In some embodiments, carrier aggregation of the plurality of carriers includes one of the following:
intra-band contiguous carrier aggregation;
intra-band non-contiguous carrier aggregation; or
inter-band carrier aggregation.

In some embodiments, the carrier aggregation includes a carrier aggregation manner in a first frequency band or a carrier aggregation manner in a second frequency band; and a frequency of the first frequency band is less than a frequency of the second frequency band.

In some embodiments, in a case that the carrier aggregation includes the intra-band contiguous carrier aggregation, a PRS on each carrier meets at least one of the following:
having a same subcarrier spacing SCS;
having a same cyclic prefix CP type;
having a same reference point;
having a same PRS periodicity;
having a same slot offset within a PRS periodicity;
having a same PRS resource repetition factor;
having a same system frame number SFN;
being in a same slot;
being on a same symbol;
having a same comb size; or
having a same PRS sequence.

In this embodiment of this application, in a case that the carrier aggregation includes the intra-band contiguous carrier aggregation, if the PRS on each carrier has one or more of the foregoing characteristics, the terminal may receive and parse the PRS on each carrier at the same time point based on the same radio frequency module. This may be applicable to a terminal configured with only one radio frequency module.

In some embodiments, the radio frequency unit 1101 is configured to send first capability information of the terminal to the network side device in a case that the carrier aggregation includes the intra-band contiguous carrier aggregation.

The first capability information of the terminal includes at least one of the following:
a frequency band in which the terminal supports positioning by using multi-carrier aggregation;
a quantity of carriers on which the terminal supports positioning by using multi-carrier aggregation; and
a maximum bandwidth on which the terminal supports positioning by using multi-carrier aggregation.

In this embodiment of this application, in a case that the carrier aggregation includes the intra-band contiguous carrier aggregation, the terminal first sends the first capability information of the terminal to the network side device, so that the network side device configures PRSs on a plurality of carriers for the terminal based on the first capability information of the terminal. This avoids a case that the terminal is incapable of processing the PRSs on the plurality of carriers configured by the network side device, thereby achieving proper utilization of resources.

In some embodiments, the radio frequency unit 1101 is further configured to send second capability information of the terminal to the network side device in a case that the carrier aggregation includes the intra-band non-contiguous carrier aggregation or the inter-band carrier aggregation.

The second capability information of the terminal includes at least one of the following:
a frequency band in which the terminal supports positioning by using multi-carrier aggregation;
a quantity of carriers on which the terminal supports positioning by using multi-carrier aggregation;
a maximum bandwidth on which the terminal supports positioning by using multi-carrier aggregation;
a timing difference between carriers;
a frequency difference between carriers;
a phase difference between carriers; or
a power difference between carriers.

In this embodiment of this application, in a case that the carrier aggregation includes the intra-band non-contiguous carrier aggregation or the inter-band carrier aggregation, the terminal first sends the second capability information of the terminal to the network side device, so that the network side device configures PRSs on a plurality of carriers for the terminal based on the second capability information of the terminal. This avoids a case that the terminal is incapable of processing the PRSs on the plurality of carriers configured by the network side device, thereby achieving proper utilization of resources.

In some embodiments, the at least one carrier is more than one carrier. The processor 1110 is further configured to:
perform PRS measurement on a plurality of carriers that do not meet at least one of the following conditions, to obtain the positioning measurement result:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

In this embodiment of this application, when at least one of the following conditions is not met: a timing difference between carriers is greater than or equal to a first threshold, a frequency difference between carriers is greater than or equal to a second threshold, a phase difference between carriers is greater than or equal to a third threshold, and a power difference between carriers is greater than or equal to a fourth threshold, the terminal separately performs PRS measurement on a plurality of carriers that do not meet the at least one condition, to obtain a positioning measurement result. In this way, a more accurate measurement result can be selected from measurement results corresponding to PRSs on all the carriers as the positioning measurement result. In some embodiments, measurement results corresponding to PRSs on all the carriers may be weighted or the like to obtain a positioning measurement result. In this way, accuracy of the positioning measurement result is improved, and thus accuracy of positioning the terminal based on the positioning measurement result is further improved.

In some embodiments, the at least one carrier is more than one carrier. The processor 1110 is further configured to:
skip performing PRS measurement on a plurality of carriers that meet at least one of the following conditions, or perform PRS measurement on a plurality of carriers that meet at least one of the following conditions, to obtain the positioning measurement result, where the positioning measurement result is not used for positioning the terminal:
a timing difference between the carriers is greater than or equal to a first threshold;
a frequency difference between the carriers is greater than or equal to a second threshold;
a phase difference between the carriers is greater than or equal to a third threshold; and
a power difference between the carriers is greater than or equal to a fourth threshold.

In some embodiments, the first threshold is a maximum timing difference allowed between the carriers;
the second threshold is a maximum frequency difference allowed between the carriers;
the third threshold is a maximum phase difference allowed between the carriers; and
the fourth threshold is a maximum power difference allowed between the carriers.

In this embodiment of this application, if at least one of the following conditions is met: a timing difference between carriers is greater than or equal to a first threshold, a frequency difference between carriers is greater than or equal to a second threshold, a phase difference between carriers is greater than or equal to a third threshold, and a power difference between carriers is greater than or equal to a fourth threshold, the terminal may not perform PRS measurement on a plurality of carriers that meet the at least one condition, and consequently, no positioning measurement result is obtained. In this case, there is no need to send a positioning measurement result to the network side device, thereby saving network resources.

In some embodiments, the processor 1110 is further configured to:
for each of the carrier aggregations, perform PRS measurement on one of the plurality of carriers to obtain the positioning measurement result; or
perform PRS measurement on the plurality of carriers to obtain a measurement result corresponding to each PRS, and determine the positioning measurement result based on a measurement result corresponding to at least one of the plurality of PRSs.

In some embodiments, the processor 1110 is further configured to:
perform PRS measurement on the one of the plurality of carriers based on at least one of the following parameters:
a subcarrier spacing SCS;
a bandwidth;
a signal-to-noise ratio; and
a total quantity of PRS resources.

In some embodiments, the processor 1110 is further configured to:
perform PRS measurement on the plurality of carriers based on at least one of the following parameters:
a subcarrier spacing SCS;
a bandwidth;
a signal-to-noise ratio; and
a total quantity of PRS resources.

In this embodiment of this application, the terminal may perform PRS measurement on one of a plurality of carriers, and directly use an obtained measurement result as a positioning measurement result. The measurement is simple and time-saving. In some embodiments, the terminal may separately perform PRS measurement on a plurality of carriers, and then select a measurement result with relatively high precision from measurement results corresponding to all PRSs as a positioning measurement result, or average or weight measurement results corresponding to all PRSs to obtain a positioning measurement result. This improves precision of the positioning measurement result and further improves precision of positioning the terminal based on the positioning measurement result.

In some embodiments, the total quantity of PRS resources is determined based on the following parameters:
a PRS resource repetition factor, a quantity of symbols occupied by the PRS resource, and a comb size of the PRS resource.

In some embodiments, the processor 1110 is further configured to:
perform PRS measurement on the at least one of the plurality of carriers during PRS measurement time.

In some embodiments, the PRS measurement time is determined based on the following parameters:
a PRS periodicity, a duration of an available PRS resource, and a maximum quantity of PRS resources in a slot.

The PRS periodicity is a least common multiple of PRS periodicities on all carriers.

The duration of the available PRS resource is a largest value among durations of PRS resources on all carriers.

The maximum quantity of PRS resources in the slot is a largest value among quantities of PRS resources in all slots on all carriers.

In this embodiment of this application, the terminal may perform PRS measurement on at least one of a plurality of carriers during PRS measurement time, so as to ensure measurement validity.

In some embodiments, the radio frequency unit 1101 is further configured to:
send the positioning measurement result to the network side device.

An embodiment of this application further provides a network side device, including a processor and a communication interface. The communication interface is configured to receive a positioning measurement result sent by a terminal. The positioning measurement result is a result obtained by performing PRS measurement on at least one of a plurality of carriers in a case that the terminal is capable of simultaneously performing PRS measurement on the plurality of carriers. The processor is configured to position the terminal based on the positioning measurement result. This network side device embodiment corresponds to the foregoing network side device method embodiment. Implementation processes and implementations of the foregoing method embodiment may all be applied to this network side device embodiment, and the same technical effects can be achieved.

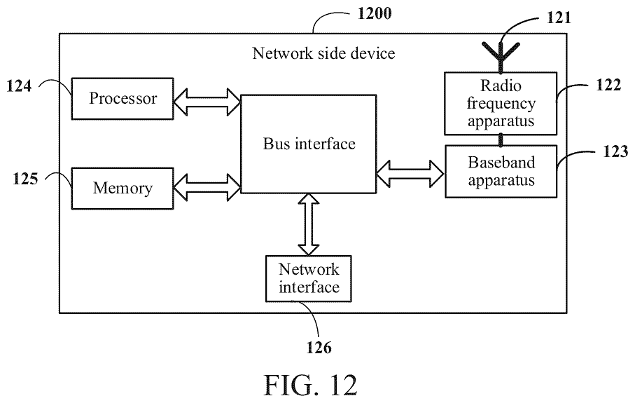

An embodiment of this application further provides a network side device. As shown in FIG. 12, the network side device 1200 includes: an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes and sends to-be-sent information to the radio frequency apparatus 122, and the radio frequency apparatus 122 processes received information and sends out the information through the antenna 121.

The method performed by the network side device in the foregoing embodiment may be implemented in the baseband apparatus 123. The baseband apparatus 123 includes a baseband processor.

The baseband apparatus 123 may include, for example, at least one baseband board. A plurality of chips are disposed on the baseband board. As shown in FIG. 12, one chip is, for example, the baseband processor, and is connected to the memory 125 through a bus interface, to call a program in the memory 125 to perform the operations of the network device shown in the foregoing method embodiment.

The network side device may further include a network interface 126. The interface is, for example, a common public radio interface (CPRI).

In some embodiments, the network side device 1200 of this embodiment of the present application further includes: an instruction or a program stored in the memory 125 and runnable on the processor 124. The processor 124 calls the instruction or the program in the memory 125 to perform the method performed by each module shown in FIG. 9, and the same technical effects are achieved. To avoid repetition, details are not described herein again.

An embodiment of this application further provides a readable storage medium, where the readable storage medium stores a program or an instruction, and the program or the instruction, when executed by a processor, implements the processes of the foregoing positioning reference signal PRS measurement method embodiment, and the same technical effects can be achieved. To avoid repetition, details are not described herein again.

The processor is the processor in the terminal described in the foregoing embodiment. The readable storage medium includes a computer-readable storage medium, such as a computer read-only memory ROM, a random access memory RAM, a magnetic disk, or an optical disc.

An embodiment of this application further provides a chip, where the chip includes a processor and a communication interface. The communication interface is coupled to the processor. The processor is configured to run a program or an instruction to implement the processes of the foregoing positioning reference signal PRS measurement method embodiment, and the same technical effects can be achieved. To avoid repetition, details are not described herein again.

It should be understood that, the chip mentioned in this embodiment of this application may also be referred to as a system on a chip, a system chip, a chip system, a system-on-chip, or the like.

An embodiment of this application further provides a computer program/program product. The computer program/program product is stored in a storage medium and is executed by at least one processor to implement the processes of the foregoing positioning reference signal PRS measurement method embodiment, and the same technical effects can be achieved. To avoid repetition, details are not described herein again.

An embodiment of this application further provides a positioning reference signal PRS measurement system, including: a terminal and a network side device. The terminal may be configured to perform the steps of the positioning reference signal PRS measurement method described above. The network side device may be configured to perform the steps of the positioning reference signal PRS measurement method described above.

It should be noted that the term “include”, “comprise”, or any other variation thereof in this specification is intended to cover a non-exclusive inclusion, so that a process, method, article, or device including a series of elements includes not only those elements but also other elements not explicitly listed, or elements inherent to such a process, method, article, or device. Without more restrictions, the elements defined by the sentence “including a . . . ” do not exclude the existence of other identical elements in the process, method, article, or apparatus including the elements. In addition, it should be noted that, the scope of the methods and apparatuses in the implementations of this application is not limited to performing the functions in the order shown or discussed, but may further include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the descriptions in the foregoing implementations, a person skilled in the art may clearly learn that the method according to the foregoing embodiment may be implemented by means of software plus a necessary universal hardware platform, or by using hardware. However, in many cases, the former is a preferred implementation. Based on such an understanding, the technical solutions of this application essentially, or a part contributing to the related art, may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods according to the embodiments of this application.

The embodiments of this application have been described above with reference to the accompanying drawings, but this application is not limited to the foregoing specific implementations. The foregoing specific implementations are only illustrative instead of restrictive. Under the inspiration of this application, without departing from the purpose of this application and the scope of protection of the claims, a person of ordinary skill in the art can still make many forms, which all fall within the protection of this application.

What is claimed is:

1. A positioning reference signal (PRS) measurement method, comprising:
performing, by a terminal, PRS measurement on at least one of a plurality of carriers to obtain a positioning measurement result when the terminal is configured to simultaneously perform PRS measurement on the plurality of carriers, wherein the positioning measurement result is used for positioning the terminal.

2. The PRS measurement method according to claim 1, wherein the positioning measurement result comprises at least one of the following:
a reference signal time difference (RSTD);
a receiving and sending time difference between receiving a PRS and sending an uplink reference signal by the terminal;
positioning reference signal-reference signal received power (PRS-RSRP);
positioning reference signal-reference signal received path power (PRS-RSRPP); or
a carrier phase.

3. The PRS measurement method according to claim 1, wherein carrier aggregation of the plurality of carriers comprises one of the following:
intra-band contiguous carrier aggregation;
intra-band non-contiguous carrier aggregation; or
inter-band carrier aggregation.

4. The PRS measurement method according to claim 3, wherein when the carrier aggregation comprises the intra-band contiguous carrier aggregation, a PRS on each carrier meets at least one of the following:
having a same subcarrier spacing (SCS);
having a same cyclic prefix (CP) type;
having a same reference point;
having a same PRS periodicity;
having a same slot offset within a PRS periodicity;
having a same PRS resource repetition factor;
having a same system frame number (SFN);
being in a same slot;
being on a same symbol;
having a same comb size; or
having a same PRS sequence.

5. The PRS measurement method according to claim 3, wherein before the performing, by a terminal, PRS measurement on at least one of a plurality of carriers, further comprising:
sending, by the terminal, first capability information of the terminal to a network side device when the carrier aggregation comprises the intra-band contiguous carrier aggregation,
wherein the first capability information of the terminal comprises at least one of the following:
a frequency band in which the terminal supports positioning by using multi-carrier aggregation;
a quantity of carriers on which the terminal supports positioning by using multi-carrier aggregation; or
a maximum bandwidth on which the terminal supports positioning by using multi-carrier aggregation.

6. The PRS measurement method according to claim 3, wherein the performing, by a terminal, PRS measurement on at least one of a plurality of carriers comprises:
for each of the carrier aggregation, performing, by the terminal, PRS measurement on one of the plurality of carriers to obtain the positioning measurement result; or
performing, by the terminal, PRS measurement on the plurality of carriers to obtain a measurement result corresponding to each PRS, and determining the positioning measurement result based on a measurement result corresponding to at least one of a plurality of PRSs.

7. The PRS measurement method according to claim 1, wherein the performing, by a terminal, PRS measurement on at least one of a plurality of carriers comprises:
performing, by the terminal, PRS measurement on the at least one of the plurality of carriers during PRS measurement time.

8. The PRS measurement method according to claim 7, wherein the PRS measurement time is determined based on the following parameters:
a PRS periodicity, a duration of an available PRS resource, and a maximum quantity of PRS resources in a slot, wherein:
the PRS periodicity is a least common multiple of PRS periodicities on all carriers;
the duration of the available PRS resource is a largest value among durations of PRS resources on all carriers; and
the maximum quantity of PRS resources in the slot is a largest value among quantities of PRS resources in all slots on all carriers.

9. A positioning reference signal (PRS) measurement method, comprising:
receiving, by a network side device, a positioning measurement result sent by a terminal, wherein the positioning measurement result is a result obtained by performing PRS measurement on at least one of a plurality of carriers when the terminal is configured to simultaneously perform PRS measurement on the plurality of carriers; and
positioning, by the network side device, the terminal based on the positioning measurement result.

10. The PRS measurement method according to claim 9, wherein the positioning measurement result comprises at least one of the following:
a reference signal time difference (RSTD);
a receiving and sending time difference between receiving a PRS and sending an uplink reference signal by the terminal;
positioning reference signal-reference signal received power (PRS-RSRP);
positioning reference signal-reference signal received path power (PRS-RSRPP); or
a carrier phase.

11. The PRS measurement method according to claim 9, wherein carrier aggregation of the plurality of carriers comprises one of the following:
intra-band contiguous carrier aggregation;
intra-band non-contiguous carrier aggregation; or
inter-band carrier aggregation.

12. The PRS measurement method according to claim 11, wherein before the receiving, by a network side device, a positioning measurement result sent by a terminal, further comprising:
receiving, by the network side device, first capability information of the terminal sent by the terminal, wherein the first capability information is sent by the terminal when the carrier aggregation comprises the intra-band contiguous carrier aggregation; and
configuring, by the network side device, PRSs on the plurality of carriers for the terminal based on the first capability information of the terminal,
wherein the first capability information of the terminal comprises at least one of the following:
a frequency band in which the terminal supports positioning by using multi-carrier aggregation;
a quantity of carriers on which the terminal supports positioning by using multi-carrier aggregation; or
a maximum bandwidth on which the terminal supports positioning by using multi-carrier aggregation.

13. The PRS measurement method according to claim 12, wherein the configuring, by the network side device, the PRSs on the plurality of carriers for the terminal based on the first capability information of the terminal meets at least one of the following:
having a same subcarrier spacing (SCS);
having a same cyclic prefix (CP) type;
having a same reference point;
having a same PRS periodicity;
having a same slot offset within a PRS periodicity;
having a same PRS resource repetition factor;
having a same system frame number (SFN);
being in a same slot;
being on a same symbol;
having a same comb size; or
having a same PRS sequence.

14. A terminal, comprising: a memory storing a computer program; and a processor coupled to the memory and configured to execute the computer program to perform operations comprising:
performing positioning reference signal (PRS) measurement on at least one of a plurality of carriers to obtain a positioning measurement result when the terminal is configured to simultaneously perform PRS measurement on the plurality of carriers, wherein the positioning measurement result is used for positioning the terminal.

15. The terminal according to claim 14, wherein the positioning measurement result comprises at least one of the following:
a reference signal time difference (RSTD);
a receiving and sending time difference between receiving a PRS and sending an uplink reference signal by the terminal;
positioning reference signal-reference signal received power (PRS-RSRP);
positioning reference signal-reference signal received path power (PRS-RSRPP); or
a carrier phase.

16. The terminal according to claim 14, wherein carrier aggregation of the plurality of carriers comprises one of the following:
intra-band contiguous carrier aggregation;
intra-band non-contiguous carrier aggregation; or
inter-band carrier aggregation.

17. The terminal according to claim 16, wherein when the carrier aggregation comprises the intra-band contiguous carrier aggregation, a PRS on each carrier meets at least one of the following:
having a same subcarrier spacing (SCS);
having a same cyclic prefix (CP) type;
having a same reference point;
having a same PRS periodicity;
having a same slot offset within a PRS periodicity;
having a same PRS resource repetition factor;
having a same system frame number (SFN);
being in a same slot;
being on a same symbol;
having a same comb size; or
having a same PRS sequence.

18. The terminal according to claim 16, wherein before the performing PRS measurement on at least one of a plurality of carriers, the operations further comprise:
sending first capability information of the terminal to a network side device when the carrier aggregation comprises the intra-band contiguous carrier aggregation,
wherein the first capability information of the terminal comprises at least one of the following:
a frequency band in which the terminal supports positioning by using multi-carrier aggregation;
a quantity of carriers on which the terminal supports positioning by using multi-carrier aggregation; or
a maximum bandwidth on which the terminal supports positioning by using multi-carrier aggregation.

19. The terminal according to claim 16, wherein the performing PRS measurement on at least one of a plurality of carriers comprises:
for each of the carrier aggregation, performing PRS measurement on one of the plurality of carriers to obtain the positioning measurement result; or
performing PRS measurement on the plurality of carriers to obtain a measurement result corresponding to each PRS, and determining the positioning measurement result based on a measurement result corresponding to at least one of a plurality of PRSs.

20. A network side device, comprising: a memory storing a computer program; and a processor coupled to the memory and configured to execute the computer program to perform the PRS measurement method according to claim 9.
